(19) United States
(12) Patent Application Publication
(10) Pub. No.: US 2026/0036058 A1
(43) Pub. Date: Feb. 5, 2026

(54) TURBINE SHROUD ASSEMBLIES WITH RETAINER FEATURES FOR BLOCKING SEAL MIGRATION

(71) Applicant: Rolls-Royce Corporation, Indianapolis, IN (US)

(72) Inventors: David J. Thomas, Indianapolis, IN (US); Ted J. Freeman, Indianapolis, IN (US); Aaron D. Sippel, Indianapolis, IN (US); Clark J. Snyder, Indianapolis, IN (US); Grant Cook, Indianapolis, IN (US); James E. Shellhorn, Indianapolis, IN (US)

(21) Appl. No.: 18/680,546

(22) Filed: May 31, 2024

(51) Int. Cl. F01D 11/00; F01D 25/24

(52) U.S. Cl. CPC F01D 11/00; F01D 25/24; F05D 2220/32; F05D 2230/60; F05D 2240/55

(57) ABSTRACT

A turbine shroud assembly includes a carrier segment, a blade track segment, and a buffer air seal assembly. The carrier segment includes a cantilevered wall extending radially inwardly within a recess so as to form a groove between the cantilevered wall and the inner wall of the recess. The buffer air seal assembly includes first, second, and third seal members arranged in the groove. The second and third seal members are aligned with each other and arranged radially outward of the first seal member. The cantilevered wall a barrier portion wider than a main portion of the wall such that the barrier portion extends at least partially into the groove. The second and third seal members are arranged on opposing circumferential sides of the barrier portion such that the barrier portion blocks circumferential movement of the second and third seal members.

### FIELD OF THE DISCLOSURE

The present disclosure relates generally to gas turbine engines, and more specifically to ceramic matrix composite components for use in the gas turbine engine.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies. Such static shrouds may be coupled to an engine case that surrounds the compressor, the combustor, and the turbine.

Some shrouds positioned in the turbine may be exposed to high temperatures from products of the combustion reaction in the combustor. Such shrouds sometimes include components made from materials that have different coefficients of thermal expansion. Due to the differing coefficients of thermal expansion, the components of some turbine shrouds expand at different rates when exposed to combustion products. In some examples, coupling such components with traditional fasteners such as rivets or bolts may not allow for the differing levels of expansion and contraction during operation of the gas turbine engine.

### SUMMARY

The present disclosure may comprise one or more of the following features and combinations thereof.

According to a first aspect of the present disclosure, a turbine shroud assembly for use with a gas turbine engine includes a carrier segment, a blade track segment, and a buffer air seal assembly. The carrier segment is made of metallic materials and arranged circumferentially at least partway around an axis, the carrier segment including an outer wall, a first support wall that extends radially inward from the outer wall and is formed to include a recess that opens radially inwardly and extends circumferentially at least partway around the axis, and a first cantilevered wall extending radially inwardly from a top wall of the recess and spaced apart from opposing inner walls of the recess so as to form a first groove between a first inner wall of the recess and a first outer wall of the first cantilevered wall that faces the first inner wall, the first cantilevered wall and the first groove extending circumferentially at least partway around the axis, the carrier segment further including at least one buffer air passageway that extends radially through the first support wall and the first cantilevered wall and is configured to discharge high-pressure buffer air.

In some embodiments, the blade track segment is made of ceramic matrix composite materials and includes a shroud wall that extends circumferentially partway around the axis and an attachment feature coupled to the carrier segment. The buffer air seal assembly is located radially between the carrier segment and the shroud wall of the blade track segment and includes a first tandem seal arranged in the first groove. The first tandem seal includes first, second, and third seal members that each extend circumferentially at least partway about the axis. The second and third seal members are aligned with each other, circumferentially spaced apart, and arranged radially outward of the first seal member. The first cantilevered wall further includes a main portion having a first axial width and a barrier portion having a second axial width greater than the first axial width such that a first axial extension of the barrier portion extends at least partially into the first groove. The second and third seal members are arranged on opposing circumferential sides of the barrier portion such that the barrier portion blocks circumferential movement of the second and third seal members.

In some embodiments, the first support wall of the carrier segment is further formed to include a second groove between a second inner wall of the recess opposite the first inner wall and a second outer wall of the first cantilevered wall that faces the second inner wall and is opposite the first outer wall.

In some embodiments, the buffer air seal assembly further includes a second tandem seal arranged in the second groove. The second tandem seal includes fourth, fifth, and sixth seal members that each extend circumferentially at least partway about the axis. The fifth and sixth seal members are aligned with each other, circumferentially spaced apart, and arranged radially outward of the fourth seal member. The barrier portion includes a second axial extension that extends at least partially into the second groove. The fifth and sixth members are arranged on opposing circumferential sides of the barrier portion such that the barrier portion blocks circumferential movement of the fifth and sixth seal members.

In some embodiments, the barrier portion of the first cantilevered wall is located centrally along a longitudinal extent of the main portion.

In some embodiments, the main portion of the first cantilevered wall further includes a bottom surface that faces radially inwardly and the first and second axial extensions of the barrier portion each include a bottom surface that faces radially inwardly, and the bottom surfaces of the first and second axial extensions are radially outwardly spaced apart from the bottom surface of the main portion.

In some embodiments, the at least one buffer air passageway includes a first buffer air passageway that extends through the barrier portion.

In some embodiments, the at least one buffer air passageway includes a second buffer air passageway that extends through the barrier portion and is circumferentially spaced apart from the first buffer air passageway.

In some embodiments, the first support wall is a forwardmost support wall of the carrier segment.

In some embodiments, the first seal member is a wire seal and the second and third seal members are a braid seal that are compressible, and the second and third seal members are configured to be compressed between the carrier segment and the first seal member to bias the first seal member into engagement with the shroud wall of the blade track segment.

In some embodiments, the second and third seal members comprise a braid of metallic material, and the second and third seal members comprise a ceramic-containing core surrounded by the braid of metallic material.

In some embodiments, the first seal member comprises a single strand of solid metallic material.

In some embodiments, the first seal member is held in relation to the second seal member via a first retaining member and held in relation to the third seal member via a second retaining member.

In some embodiments, the first retaining member includes a first plurality of teeth. The first seal member is arranged in a groove formed between a first set of teeth of the first plurality of teeth and the second seal member is arranged in a groove formed between a second set of teeth of the first plurality of teeth. The second retaining member includes a second plurality of teeth. The first seal member is arranged in a groove formed between a third set of teeth of the second plurality of teeth and the third seal member is arranged in a groove formed between a fourth set of teeth of the second plurality of teeth.

According to a further aspect of the present disclosure, a turbine shroud assembly for use with a gas turbine engine includes a carrier segment arranged circumferentially at least partway around an axis, the carrier segment including a first support wall including a recess that opens radially inwardly, and a first cantilevered wall arranged within the recess and spaced apart from opposing inner walls of the recess so as to form a first groove between one of the inner walls and the first cantilevered wall, the carrier segment further including a buffer air passageway that extends radially through the first support wall and the first cantilevered wall. The turbine shroud assembly further includes a blade track segment coupled to the carrier segment, and a buffer air seal assembly including a first tandem seal arranged in the first groove. The first tandem seal includes first and second seal members, and the second seal member is arranged radially outward of the first seal member. The first cantilevered wall further includes a barrier portion, and the second seal member is arranged on a circumferential side of the barrier portion such that the barrier portion blocks circumferential movement of the second seal member.

In some embodiments, the buffer air seal assembly is located radially between the carrier segment and a shroud wall of the blade track segment, the first tandem seal further includes a third seal member arranged in the first grooves, and the second and third seal members are aligned with each other, circumferentially spaced apart, and arranged radially outward of the first seal member.

In some embodiments, the first cantilevered wall further includes a main portion having a first axial width, the barrier portion has a second axial width greater than the first axial width such that a first axial extension of the barrier portion extends at least partially into the first groove, and the second and third seal members are arranged on opposing circumferential sides of the barrier portion such that the barrier portion blocks circumferential movement of the second and third seal members.

In some embodiments, the first support wall of the carrier segment is further formed to include a second groove between the other of the inner walls of the recess and the first cantilevered wall.

In some embodiments, the buffer air seal assembly further includes a second tandem seal arranged in the second groove, the second tandem seal includes fourth, fifth, and sixth seal members that each extend circumferentially at least partway about the axis, and the fifth and sixth seal members are aligned with each other, circumferentially spaced apart, and arranged radially outward of the fourth seal member. The barrier portion includes a second axial extension that extends at least partially into the second groove, and the fifth and sixth members are arranged on opposing circumferential sides of the barrier portion such that the barrier portion blocks circumferential movement of the fifth and sixth seal members.

In some embodiments, the buffer air passageway extends through the barrier portion.

According to a further aspect of the present disclosure, a method includes arranging a carrier segment made of metallic materials circumferentially at least partway around an axis, the carrier segment including an outer wall and a first support wall that extends radially inward from the outer wall, forming the first support wall to include a recess that opens radially inwardly and extends circumferentially at least partway around the axis, and a first cantilevered wall extending radially inwardly from a top wall of the recess and spaced apart from opposing inner walls of the recess so as to form a first groove between a first inner wall of the recess and a first outer wall of the first cantilevered wall that faces the first inner wall, the first cantilevered wall and the first groove extending circumferentially at least partway around the axis, and forming at least one buffer air passageway in the carrier segment that extends radially through the first support wall and the first cantilevered wall and is configured to discharge high-pressure buffer air.

The method further includes coupling an attachment feature of a blade track segment made of ceramic matrix composite materials to the carrier segment, the blade track segment including a shroud wall that extends circumferentially partway around the axis, arranging a buffer air seal assembly radially between the carrier segment and the shroud wall of the blade track segment, the buffer air seal assembly including a first tandem seal arranged in the first groove, wherein the first tandem seal includes first, second, and third seal members that each extend circumferentially at least partway about the axis, wherein the second and third seal members are aligned with each other, circumferentially spaced apart, and arranged radially outward of the first seal member, wherein the first cantilevered wall further includes a main portion having a first axial width and a barrier portion having a second axial width greater than the first axial width such that a first axial extension of the barrier portion extends at least partially into the first groove, and arranging the second and third seal members on opposing circumferential sides of the barrier portion such that the barrier portion blocks circumferential movement of the second and third seal members.

These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan, a compressor, a combustor, and a turbine and suggesting that the turbine includes turbine wheel assemblies and static vane assemblies surrounded by a turbine shroud assembly;

FIG. 2 is a partial cross-sectional view of the gas turbine engine of FIG. 1 showing a portion of the turbine in which the turbine shroud assembly is located radially outward from blades of a turbine wheel assembly to block gasses from passing over the blades without interacting with the blades, and further showing the turbine shroud assembly includes a carrier segment, a blade track segment coupled to the carrier segment to define a portion of a gas path of the gas turbine engine, and a buffer air seal assembly configured to seal between the carrier segment and the blade track segment to block gases flowing through the gas path from flowing between the carrier segment and the blade track segment;

FIG. 3 is side cross-sectional view of the turbine shroud assembly of FIG. 2, showing that a first support wall of the carrier segment includes a circumferentially extending first recess having a first cantilevered wall therewithin and defining two circumferentially extending grooves, and showing that the buffer air seal assembly can include first and second tandem seals arranged within the grooves;

FIG. 4 is a cross-sectional magnified view of the turbine shroud assembly of FIG. 3 taken through line 4-4 shown in FIG. 5, showing that the first and second tandem seals each include a first seal member and a second seal member arranged radially outwardly of the first seal member, showing that the first cantilevered wall includes a main portion having a first axial width and a barrier portion having second axial width greater than the first axial width so as to extend at least partially into the first and second grooves, and showing that the second, radially-outwardly arranged seal members of the first and second tandem seals are arranged on a circumferential side of the barrier portion so as to block circumferential movement of the second seal members;

FIG. 5 is a top cross-section view of the turbine shroud assembly of FIGS. 3 and 4 taken through line 5-5 shown in FIG. 4, showing that the first and second tandem seals each include two radially-outwardly arranged seal members arranged on opposing circumferential sides of the barrier portion of the first cantilevered wall;

FIG. 6 is an axially-facing cross-sectional view of turbine shroud assembly of FIGS. 3-5 taken through line 6-6 shown in FIG. 5, showing the two radially-outwardly arranged seal members of one of the tandem seals arranged on opposing circumferential sides of the barrier portion of the first cantilevered wall;

FIG. 7 is a top cross-section view of a turbine shroud assembly according to a further aspect of the present disclosure, the turbine shroud assembly including a carrier segment including a first recess having a first cantilevered wall therewithin and defining two circumferentially extending grooves, and a buffer air seal assembly including first and second tandem seals arranged within the grooves, showing that the first and second tandem seals each include a first seal member and second and third seal members arranged radially outwardly of the first seal member, showing that the second and third, radially-outwardly arranged seal members of the first and second tandem seals are arranged on opposing circumferential side of a barrier portion of the first cantilevered wall so as to block circumferential movement of the second seal members, and showing that the first seal members can be coupled to the second and third seal members via retaining members;

FIG. 8 is a cross-sectional magnified view of the turbine shroud assembly of FIG. 7, showing that the retaining members include a plurality of teeth and the seal members is arranged in grooves formed between teeth of the retaining members,

FIG. 9 is a top cross-section view of a turbine shroud assembly according to a further aspect of the present disclosure, the turbine shroud assembly including a carrier segment including a first recess having a first cantilevered wall therewithin and defining two circumferentially extending grooves, and a buffer air seal assembly including first and second tandem seals arranged within the grooves, showing that the first and second tandem seals each include a first seal member and a second seal member arranged radially outwardly of the first seal member, showing that the second, radially-outwardly arranged seal members of the first and second tandem seals bend around a plurality of barrier portions of the first cantilevered wall so as to block circumferential movement of the second seal members;

FIG. 10 is a cross-sectional magnified view of the turbine shroud assembly of FIG. 9 taken through line 10-10 shown in FIG. 9, showing that the portions of the second, radially-outwardly arranged seal members of the first and second tandem seals that bend around the barrier portions of the first cantilevered wall are at least partially arranged within sub-recesses formed in the inner walls of the first recess;

FIG. 11 is side cross-sectional view of a turbine shroud assembly according to a further aspect of the present disclosure, showing that a first support wall of the carrier segment includes a circumferentially extending first recess having a first cantilevered wall therewithin and defining two circumferentially extending grooves, showing that the buffer air seal assembly can include first and second tandem seals arranged within the grooves, and showing that the first cantilevered wall includes axially outer walls that are angled;

FIG. 12 is a cross-sectional magnified view of the turbine shroud assembly of FIG. 11 taken through line 12-12 shown in FIG. 13, showing that the first and second tandem seals each include a first seal member and a second seal member arranged radially outwardly of the first seal member, showing that the first cantilevered wall includes a main portion having a first axial width and a barrier portion having second axial width greater than the first axial width so as to extend at least partially into the first and second grooves, and showing that the second, radially-outwardly arranged seal members of the first and second tandem seals are arranged on a circumferential side of the barrier portion so as to block circumferential movement of the second seal members; and

FIG. 13 is a top cross-section view of the turbine shroud assembly of FIGS. 11 and 12 taken through line 13-13 shown in FIG. 12, showing that the first and second tandem seals each include two radially-outwardly arranged seal members arranged on opposing circumferential sides of the barrier portion of the first cantilevered wall.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

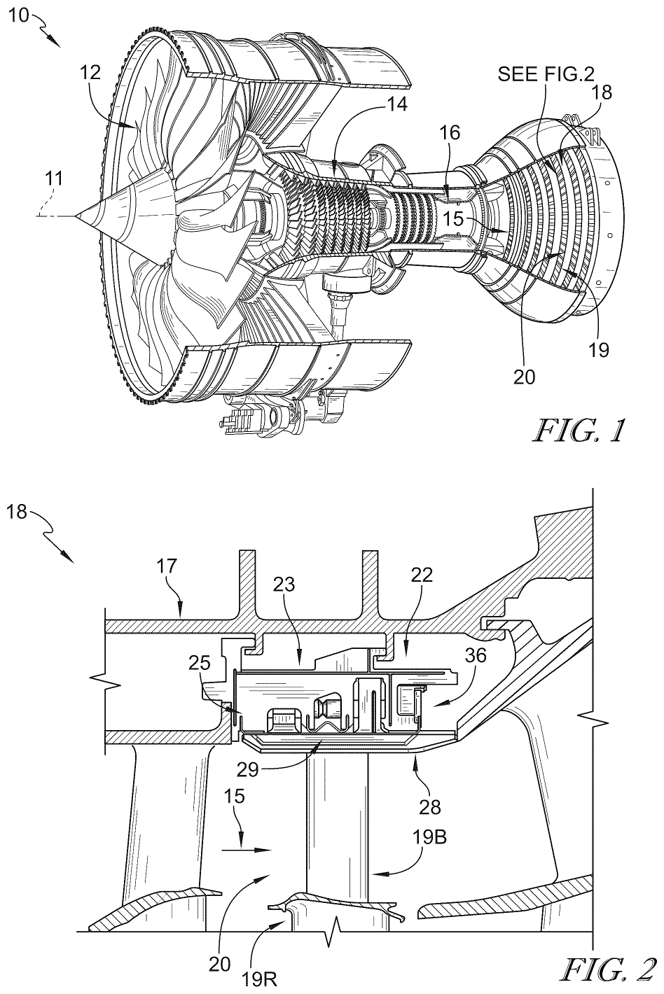

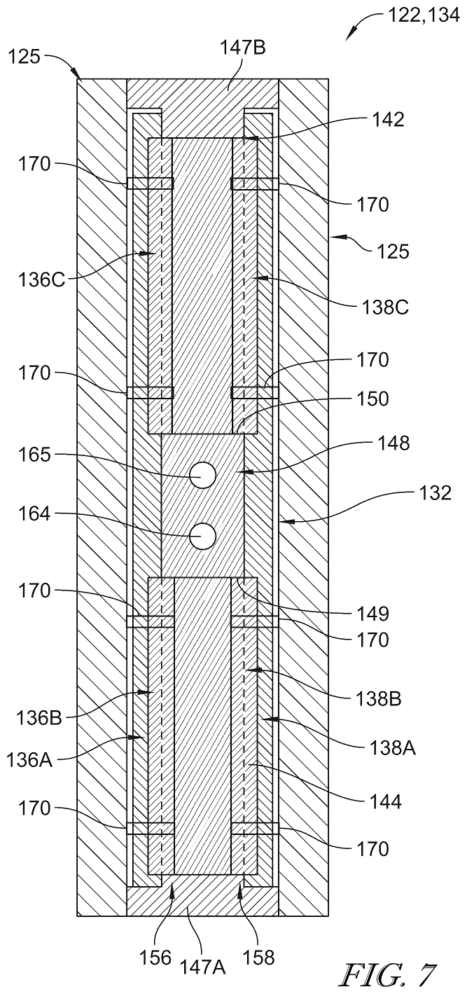

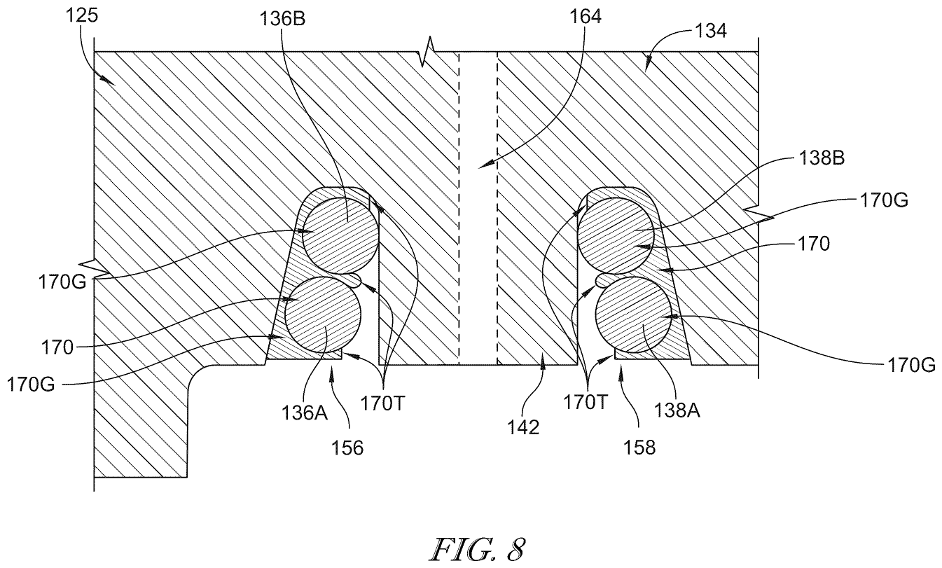

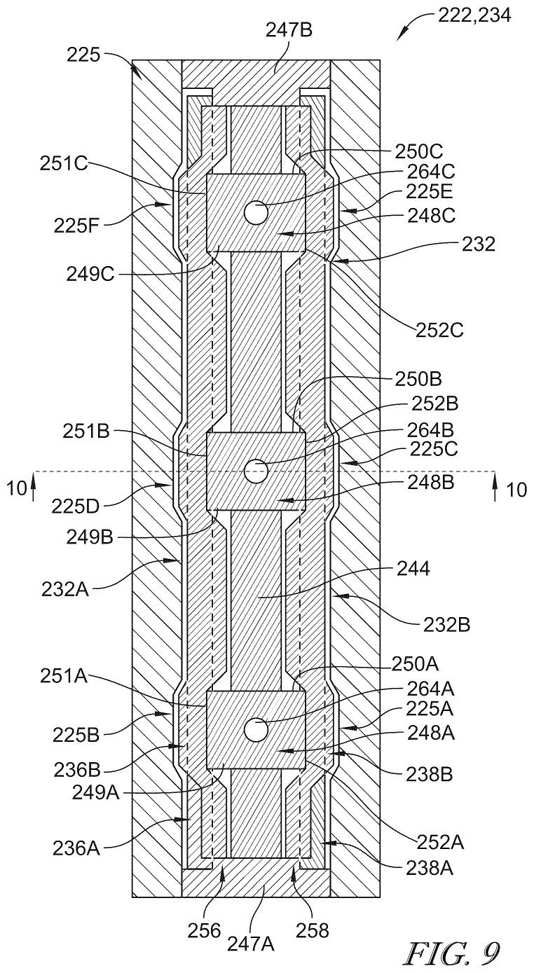

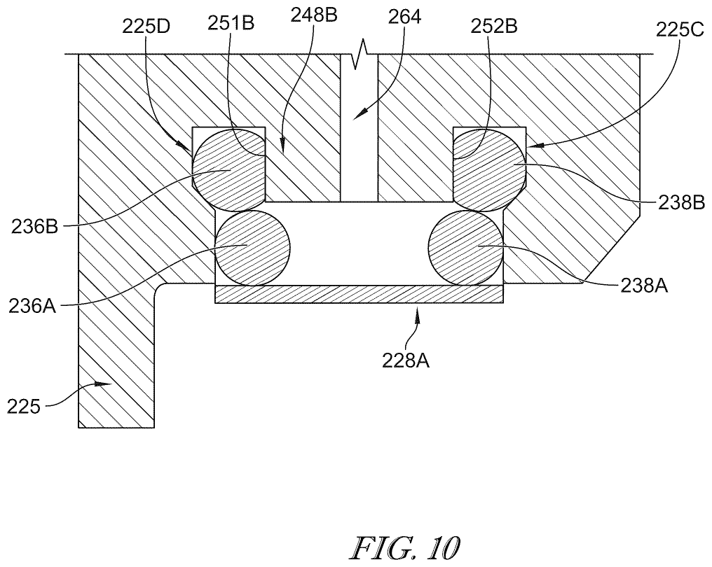

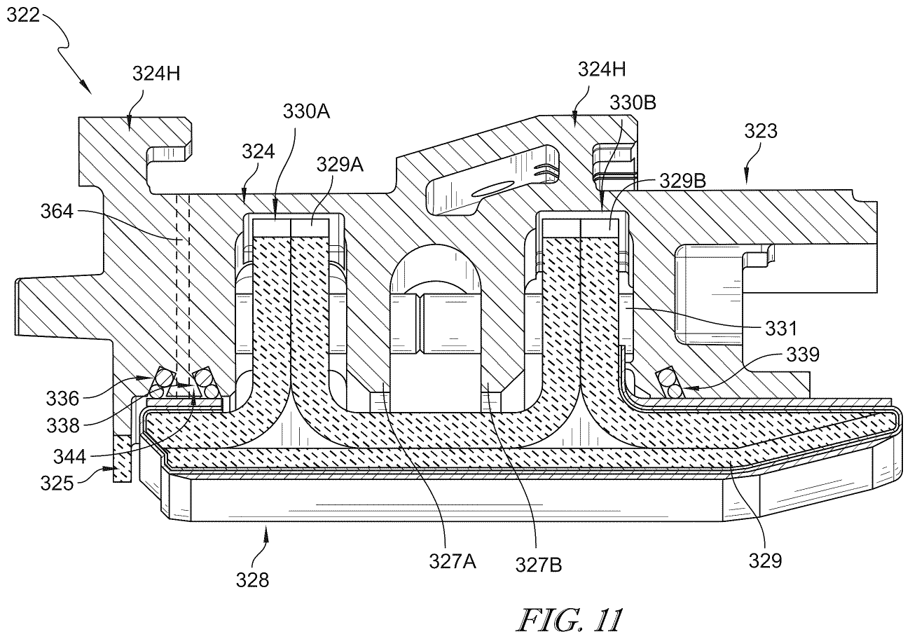

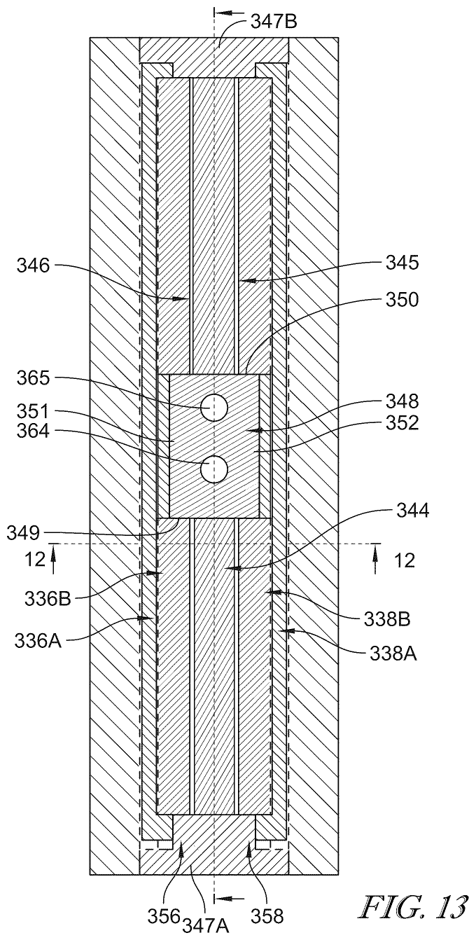

A first embodiment of a turbine shroud segment 22, also referred to herein as a turbine shroud assembly 22, for use in a turbine shroud 20 of a turbine 18 of a gas turbine engine 10 (as illustrated in FIG. 1) is shown in FIGS. 2-6. A second embodiment of a turbine shroud assembly 122 is shown in FIGS. 7 and 8. A third embodiment of a turbine shroud assembly 222 is shown in FIGS. 9 and 10. A fourth embodiment of a turbine shroud assembly 322 is shown in FIGS. 11-13.

In at least one embodiment, the turbine shroud assembly 22 includes a carrier segment 23 having a circumferentially extending recess 32 formed therein, the recess 32 including a first cantilevered wall 42 therein that defines two grooves 56, 58 within the recess 32. Two tandem seals 36, 38 are arranged within the grooves 56, 58, respectively, each tandem seal including a radially inward first seal member 36A, 38A and two radially outward seal members 36B, 36C, 38B, 38C. The radially outward seal members 36B, 36C, 38B, 38C are arranged on opposing sides of a barrier portion 48 of the first cantilevered wall 42 so as to block circumferential movement of the radially outward seal members 36B, 36C, 38B, 38C.

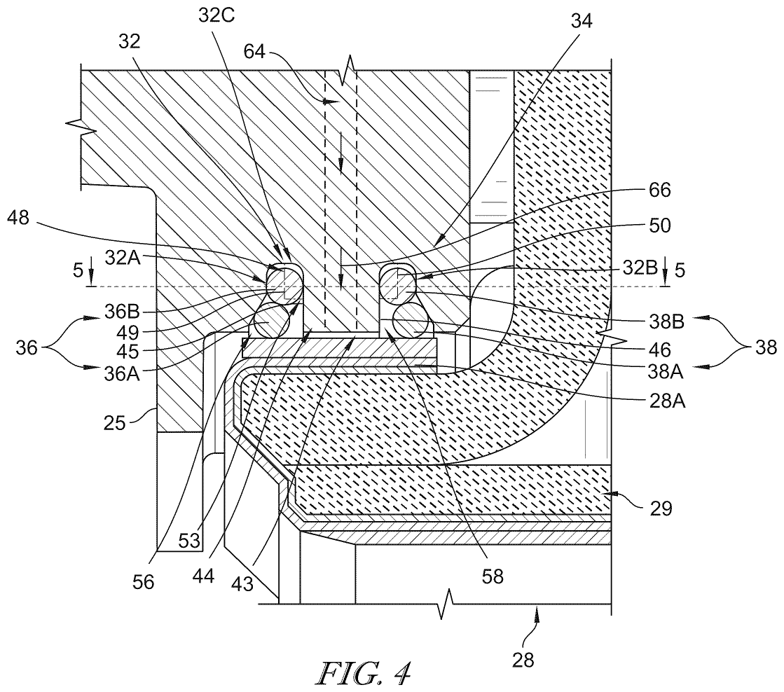

A person skilled in the art will understand that the second seal members 36B, 36C, 38B, 38C of the two tandem seals 36, 38 may also be referred to as seal “energizers” 36B, 36C, 38B, 38C. As will be described in detail below, in operation, the seal energizers 36B, 36C, 38B, 38C perform a biasing function that biases the first seal members 36A, 38A into engagement with the blade track segment 28 (specifically a coating 28A formed on the blade track segment 28, as shown in FIG. 4). The seal energizers 36B, 36C, 38B, 38C do not provide a sealing function, as the sealing function is performed by the first seal members 36A, 38A, in particular to prevent or block gases from a gas path 15 of the gas turbine engine 10 from flowing between the carrier segment 23 and the blade track segment 28.

The gas turbine engine 10 in which the turbine shroud assembly 22, 122, 222, 322 of the present disclosure can be utilized includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about an axis 11 and drive the compressor 14 and the fan 12. In some embodiments, the fan may be replaced with a propeller, drive shaft, or other suitable configuration.

The turbine 18 includes at least one turbine wheel assembly 19 and a turbine shroud 20 positioned to surround the turbine wheel assembly 19 as shown in FIGS. 1 and 2. The turbine wheel assembly 19 includes a plurality of blades 19B coupled to a rotor disk 19R for rotation with the disk 19R. The hot, high pressure combustion products from the combustor 16 are directed toward the blades 19B of the turbine wheel assemblies 19 along the gas path 15. The turbine shroud 20 is coupled to the outer case 17 of the gas turbine engine 10 and extends around the turbine wheel assembly 19 to block gases from passing over the turbine blades 19B during use of the turbine 18 in the gas turbine engine 10.

In the illustrative embodiment, the turbine shroud 20 is made up of a number of turbine shroud segment segments 22 that each extend circumferentially partway around the axis 11 and cooperate to surround the turbine wheel assembly 19. In other embodiments, the turbine shroud 20 is annular and non-segmented to extend fully around the axis 11 and surround the turbine wheel assembly 19. In yet other embodiments, certain components of the turbine shroud 20 are segmented while other components are annular and non-segmented.

The turbine shroud segment 22 includes a carrier segment 23 arranged circumferentially at least partway around an axis 11 of the gas turbine engine 10, a blade track segment 28 arranged circumferentially at least partway around the axis 11, a mount system 31 configured to couple the carrier segment 23 to the blade track segment 28, and a seal system 34 as shown in FIGS. 2-6. The seal system 34 is configured to seal gaps between the carrier segment 23 and the blade track segment 28 to prevent or block gases from a gas path 15 of the gas turbine engine 10 from flowing between the carrier segment 23 and the blade track segment 28.

Each turbine shroud segment 22 includes the carrier segment 23, the blade track segment 28, the mount system 31, and the seal system 34, as shown in FIGS. 2-6. The carrier segment 23 and the blade track segment 28 are arranged circumferentially partway about the axis 11. Illustratively, the carrier segment 23 includes an outer wall 24, a forwardmost support wall 25, also referred to as a first support wall 25, an aftmost support wall 26, and a pair of hangers 24H. The outer wall 23 extends circumferentially at least partway about the axis 11. The hangers 24H extend radially outward from the outer wall 24 and engage the case 17 to couple the turbine shroud segment 22 to the rest of the engine 10. The first support wall 25 extends radially inward from the outer wall 24 at a forward end of the outer wall 24 axially forward of a first attachment feature 29A of the blade track segment 28, and the aft support wall 26 extends radially inward from the outer wall 24 at an aft end of the outer wall 24 axially aft of a second attachment feature 29B of the blade track segment 28.

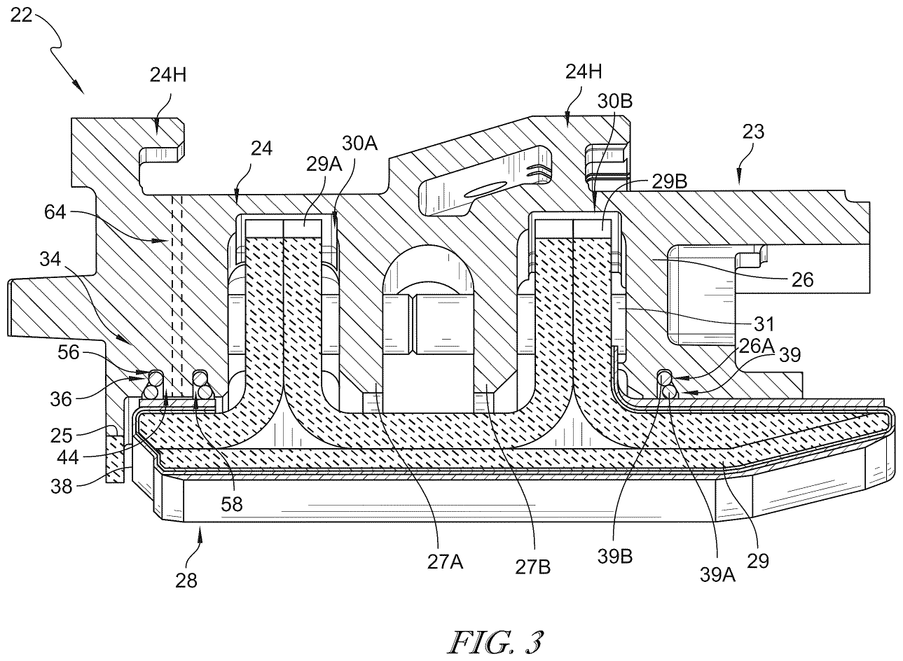

In the illustrative embodiment, the carrier segment 23 further includes two intermediate support walls 27A, 27B as shown in FIG. 3. The intermediate support walls 27A, 27B each extend radially inward from the outer wall 24 of the carrier segment 23 axially between the first and second support walls 25, 26. A forwardmost intermediate support walls 27A is spaced apart axially from an aftmost intermediate support walls 27B in the illustrative embodiment.

In the illustrative embodiment, the blade track segment 28 includes a shroud wall 29 that extends circumferentially partway around the axis 11 to define a portion of the gas path 15 and first and second attachment features 29A, 29B that extend radially from the shroud wall 29. The first attachment feature 29A extends into a first attachment-receiving space 30A defined between the first support wall 25 and the forwardmost intermediate support wall 27A, and the second attachment feature 29B extends into a second attachment-receiving space 30B defined between the aft support wall 26 and the aftmost intermediate support wall 27B. The mount system 31, which may be a pin or similar retainer feature, is configured to extend through the first, second, and intermediate support walls 25, 26, 27A, 27B, as well as the first and second attachment features 29A, 29B, so as to couple the blade track segment 28 to the carrier segment 23. The seal system 34 is arranged radially between the carrier segment 24 and the blade track segment 26 to seal gaps therebetween.

The blade track segment 28 is a ceramic matrix composite component configured to directly face the high temperatures of the gas path 15 of the gas turbine engine 10 to define a portion of the gas path 15. The carrier segment 23 is a metallic support component configured to interface with other metallic components of the gas turbine engine 10, such as the case 17, to support the blade track segment 28 to radially locate the blade track segment 28 relative to the axis 11. The seal system 34 is arranged radially between the carrier segment 23 and the blade track segment 28 to seal off the first attachment-receiving space 30A defined by the carrier segment 23 to block gases from flowing between the carrier segment 23 and the blade track segment 28 and into the first attachment-receiving space 30A.

During operation of a gas turbine engine 10, the hot, high-pressure products directed into the turbine 18 from the combustor 16 flow across a radially-inward facing surface of the shroud wall 29 of the blade track segment 28 that defines a portion of the gas path 15. The seal system 34 blocks the hot, high-pressure products from flowing into the first attachment-receiving space 30A of the turbine shroud segment 22.

In the illustrative embodiment, and as will be described in greater detail below, the seal system 34 includes a first tandem seal 36 and a second tandem seal 38 arranged within grooves 56, 58 defined within a circumferentially extending recess 32 formed in the first support wall 25. Each tandem seal 36, 38 includes a radially inward first seal member 36A, 38A and two radially outward seal members 36B, 36C, 38B, 38C, also referred to as second and third seal members 36B, 36C, 38B, 38C. The seal members 36A, 36B, 36C, 38A, 38B, 38C block the hot, high-pressure products from flowing into the first attachment-receiving space 30A of the turbine shroud segment 22.

In some embodiments, the carrier segment 23 may also include buffer air passageways to direct high-pressure air (sometimes referred to as buffer air 66) into the grooves 56, 58 formed in the carrier segment 23 to distribute the high-pressure air along the seal members 36A, 36B, 36C, 38A, 38B, 38C. The high-pressure air supplied to the grooves 56, 58 is used help keep the gases in the gas path 15 out of the first attachment-receiving space 30A in the event of a seal failure. The high-pressure or buffer air 66 is typically jetted through the seal members 36A, 36B, 36C, 38A, 38B, 38C arranged in the groove 56, 58, which may cause the seal members 36A, 36B, 36C, 38A, 38B, 38C to wear, specifically oxidize, significantly reducing the overall life of the seal members 36A, 36B, 36C, 38A, 38B, 38C and the effectiveness of the seal members 36A, 36B, 36C, 38A, 38B, 38C.

In order to mitigate such negative effects, the seal system 34 of the turbine shroud segment 22, the seal system 34, which also may be referred to as a buffer air seal assembly 34, includes first and second tandem seals 36, 38 that are each arranged in their own discrete groove 56, 58 formed in the circumferentially extending recess 32 of the carrier segment 23, and further includes at least one buffer air passageway 64 that extends axially between the first and second tandem seals 36, 38. Accordingly, instead of jetting the buffer air 66 through the seal members 36A, 36B, 36C, 38A, 38B, 38C of each seal 36, 38, the buffer air passageway 64 discharges the buffer air 66 axially between the tandem seals 36, 38 so that the seal members 36A, 36B, 36C, 38A, 38B, 38C of each tandem seal 36, 38 are positioned out of a flow path of the buffer air 66. By locating the seal members 36A, 36B, 36C, 38A, 38B, 38C out of the flow path of the discharged buffer air 66 so that buffer air 66 does not flow across the seal members 36A, 36B, 36C, 38A, 38B, 38C, the oxidation or wear of the seal members 36A, 36B, 36C, 38A, 38B, 38C is reduced, improving the life of the seal members 36A, 36B, 36C, 38A, 38B, 38C.

As can be seen in detail in FIGS. 4-6, the first support wall 25 of the carrier segment 23 is formed to include the recess 32 that opens radially inwardly and extends circumferentially at least partway around the axis 11. The recess 32 includes opposing inwardly and axially facing surfaces 32A, 32B, also referred to as first and second inner walls 32A, 32B herein, and a radially inwardly facing top surface 32C that extends between the inner walls 32A, 32B, also referred to as a top wall 32C herein. In some embodiments, the inner walls 32A, 32B are angled relative to the radial direction (i.e. vertical direction as viewed in FIG. 4).

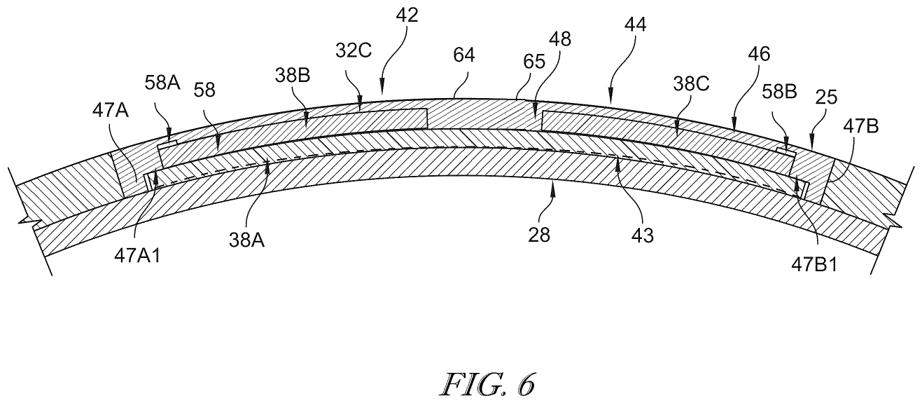

The first support wall 25 further includes a first cantilevered wall 42 extending radially inwardly from the top wall 32C of the recess 32 and spaced apart from the first and second inner walls 32A, 32B of the recess 32, as shown in FIGS. 4-6. The first cantilevered wall 42 is generally prismatic and extends along a circumferential length of the recess 32 along the top wall 32C. The first cantilevered wall 42 includes a radially inwardly facing bottom surface 43, and opposing axially facing outer surfaces 45, 46, also referred to as a first outer wall 45 and a second outer wall 46 herein. In some embodiments, the first cantilevered wall 42 has a radial extent that is generally equal to the radial depth of the recess 32, as shown in FIGS. 4 and 6. In some embodiments, the first and second outer walls 45, 46 are formed to be orthogonal to the top wall 32C and to the radial direction (i.e. vertical direction as viewed in FIG. 4).

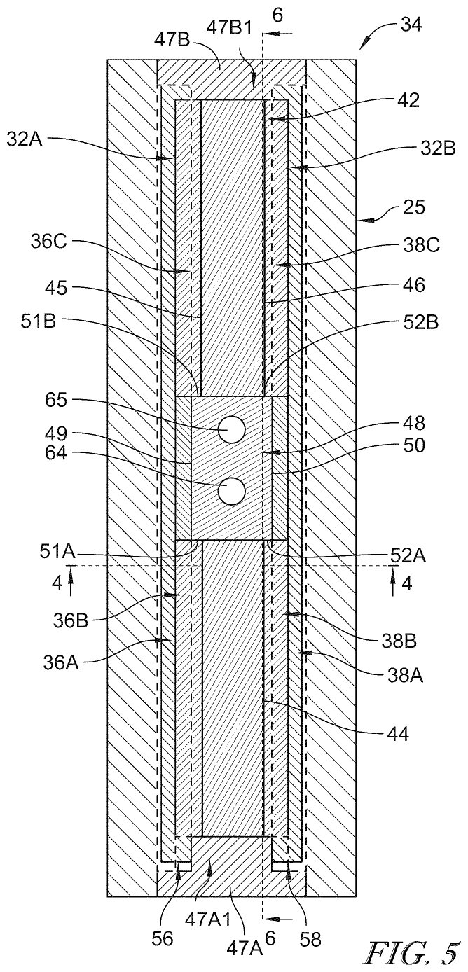

A first groove 56 is formed between the first inner wall 32A of the recess 32 and the first outer wall 45 of the first cantilevered wall 42, as shown in FIG. 4. Similarly, a second groove 58 is formed between the second inner wall 32B of the recess 32 and the second outer wall 46 of the first cantilevered wall 42. In some embodiments, the first support wall 25 may be formed to include end stops 47A, 47B at the circumferentially terminal ends of the grooves 56, 58, as shown in FIG. 5. The first support wall 25 further includes the at least one buffer air passageway 64 that extends radially through the first support wall 25 and the first cantilevered wall 42. The buffer air passageway 64 opens at the bottom surface 43 of the first cantilevered wall 42 and is configured to discharge buffer air 66 axially between the tandem seals 36, 38. In some embodiments, the first support wall 25 can include two or more buffer air passageways 64, 65, as shown in FIG. 5. In some embodiments, two buffer air passageways 64, 65 may extend through a barrier portion 48 of the first cantilevered wall 42 and may be circumferentially spaced apart.

As can be seen in phantom lines in FIG. 4 and in a top view in FIG. 5, the first cantilevered wall 42 further includes a main portion 44 having a first axial width and a barrier portion 48 formed generally centrally along a longitudinal extent (circumferential direction) of the main portion 44 and having second axial width greater than the first axial width. As shown in FIG. 4, in some embodiments, the barrier portion 48 has a radial extent that is approximately half of the radial extent of the main portion 44 such that a bottom surface 53 of the barrier portion 48 is radially outward of the first seal members 36A, 38A of the tandem seals 36, 38. In other words, the first and second axial extensions 49, 50 each include a bottom surface (which may be referred to as the bottom surface 53) that faces radially inwardly, and the bottom surfaces 53 of the first and second axial extensions 49, 50 are radially outwardly spaced apart from the bottom surface 43 of the main portion 44.

Due to the barrier portion 48 having a greater axial width than the main portion 44, the barrier portion 48 thus includes two axial extensions 49, 50, also referred to as a first axial extension 49 and a second axial extensions 50. As can be seen in FIGS. 4 and 5, the first axial extension 49 extends at least partially into the first groove 56, and similarly, the second axial extension 50 extends at least partially into the second groove 58. The first axial extension 49 includes a first circumferentially facing surface 51A and a second circumferentially facing surface 51B opposite the first circumferentially facing surface 51A. Similarly, the second axial extension 50 includes a first circumferentially facing surface 52A and a second circumferentially facing surface 52B opposite the first circumferentially facing surface 52A. As will be described in greater detail below, the second and third seal members 36B, 36C, 38B, 38C are arranged on opposing sides of the first and second axial extensions 49, 50 of the barrier portion 48 so as to block circumferential movement of the second and third seal members 36B, 36C, 38B, 38C.

FIG. 4 shows the first and second axial extensions 49, 50 of the barrier portion 48 extending to approximately half of the width (diameter) of the second and third seal members 36B, 36C, 38B, 38C. Although this is sufficient to block circumferential movement of the second and third seal members 36B, 36C, 38B, 38C, in some embodiments, the first and second axial extensions 49, 50 may have larger or smaller axial extents those shown in FIG. 4. For example, in some embodiments, the first and second axial extensions 49, 50 may extend beyond the halfway point of the diameter of the second and third seal members 36B, 36C, 38B, 38C, such as extending entirely to the inner walls 32A, 32B of the recess 32. In other embodiments, the first and second axial extensions 49, 50 may extend only slightly in the axial direction, such as to a quarter point of the diameter of the second and third seal members 36B, 36C, 38B, 38C when viewed in FIG. 4.

As shown in FIGS. 3-6, the buffer air seal assembly 34 includes a first tandem seal 36 arranged in the first groove 56 and a second tandem seal 38 arranged in the second groove 58. Each tandem seal 36, 38 includes a first seal member 36A, 38A, a second seal member 36B, 38B, and a third seal member 36C, 38C. The seal members 36A, 36B, 36C, 38A, 38B, 38C each extend circumferentially at least partway about the axis 11, with the first seal members 36A, 38A being longer than the second and third seal members 36B, 36C, 38B, 38C, as shown in FIG. 5. The second and third seal members 36B, 36C, 38B, 38C are arranged radially outward of the first seal member 36A, 38A in the corresponding groove 56, 58 so that the second and third seal members 36B, 36C, 38B, 38C are positioned out of the flow path of the buffer air 66 to reduce oxidation of the second and third seal members 36B, 36C 38B, 38C.

As suggested by FIG. 4, the seal members 36A, 36B, 36C, 38A, 38B, 38C are positioned against the first and second inner walls 32A, 32B of the recess 32. Because in the illustrative embodiment the first and second inner walls 32A, 32B are angled, the first seal members 36A, 38A are positioned slightly axially outward of the second and third seal members 36B, 36C, 38B, 38C.

As shown in FIG. 5, the second and third seal members 36B, 36C, 38B, 38C are formed to be slightly less than half of the length of first seal members 36A, 38A. In some embodiments, the first seal member 36A of the first tandem seal 36 is the same length as the first seal member 38A of the second tandem seal 38. Similarly, the second and third seal members 36B, 36C of the first tandem seal 36 is the same length as the second and third seal members 38B, 38C of the second tandem seal 38.

As briefly described above, the second and third seal members 36B, 36C, 38B, 38C are arranged on opposing sides of the first and second axial extensions 49, 50 of the barrier portion 48. In particular, as can be seen in FIG. 5, the first seal members 36A, 38A (shown in phantom lines in FIG. 5) is configured to extend radially inwardly of the barrier portion 48. Illustratively, circumferentially terminal ends of the second seal members 36B, 38B are configured to engage the first circumferentially facing surface 51A of the first axial extension 49 of the barrier portion 48 and the first circumferentially facing surface 52A of the second axial extension 50, respectively. Similarly, circumferentially terminal ends of the third seal members 36C, 38C are configured to engage the second circumferentially facing surface 52A of the first axial extension 49 and the second circumferentially facing surface 52B of the second axial extension 50, respectively.

Due to the engagement of the second and third seal members 36B, 36C, 38B, 38C with the barrier portion 48, the barrier portion 48 is configured to block circumferential movement of the second and third seal members 36B, 36C, 38B, 38C in a direction toward the barrier portion 48. The end stops 47A, 47B can be configured to block circumferential movement of the first seal members 36A, 38A, as can be seen in FIGS. 5 and 6. In some embodiments, the end stops 47A, 47B can each include an overhang 47A1, 47A2 that extends circumferentially inwardly toward the barrier portion 48 and that are each configured to block circumferential movement of the second and third seal members 36B, 36C, 38B, 38C in a direction away from the barrier portion 48. In this way, the second and third seal members 36B, 36C, 38B, 38C may be formed to be slightly shorter than the first seal members 36A, 38A.

Moreover, in some embodiments, the grooves 56, 58 can be formed to have a slightly larger circumferential length than the first seal members 36A, 38A to allow for play and/or thermal expansion within the grooves 56, 58, as shown in FIG. 5. Similarly, as can also be seen in FIG. 5, the grooves 56, 58 can be formed to have a slightly larger circumferential length than a total length of the second and third seal members 36B, 36C, 38B, 38C and the barrier portion 48 to allow for play and/or thermal expansion within the grooves 56, 58.

In some embodiments, as can be seen in FIG. 6, the grooves 56, 58 may each include pockets 56A, 58A, 56B, 58B that are located at opposing terminal sides of the grooves 56, 58 and that are recessed radially outwardly into the top wall 32C of the first support wall 25. Although the recesses 56A, 56B are not shown in FIG. 6 due to the orientation of the view in this figure, the pockets 56A, 56B are formed the same as the pockets 58A, 58B. A person skilled in the art will understand that the pockets 56A, 58A, 56B, 58B can be formed differently than each other depending on the design considerations of the grooves 56, 58 and the seal members 36A, 38A, 36B, 36C, 38B, 38C arranged therein. The pockets 56A, 58A, 56B, 58B may extend circumferentially inwardly less than a total length of the distance from the end stop overhang 47A1, 47B1 to the barrier portion 48, and may include a depth that is less than the depth of the grooves 56, 58. The pockets 56A, 58A, 56B, 58B are provided to avoid over-compressing the second and third seal members 36B, 36C, 38B, 38C by allowing the second and third seal members 36B, 36C, 38B, 38C to slightly move and expand into the pockets 56A, 58A, 56B, 58B.

A person skilled in the art will understand that it may be advantageous to utilize the two outer seals or energizers 36B, 36C, 38B, 38C circumferentially spaced apart from each other such that it is not necessary to route the two outer seals or energizers 36B, 36C, 38B, 38C around the buffer air passageways 64, 65. Thus, the walls of the first cantilevered wall 42 can be formed to be thicker (axially wider) in the area of the buffer air passageways 64, 65 (i.e. in the area of the main portion 44). In this way, enough material of the wall 42/main portion 44 is provided on axially outer sides of the buffer air passageways 64, 65 so as to create a structurally sound cantilevered wall 42 along its entire longitudinal length. In some designs, utilizing the axially thicker main portion 44 can avoid having potentially too thin/too little of material between the axially outer sides of the wall 42 and the buffer air passageways 64, 65.

Illustratively, the first seal member 36A, 38A of each tandem seal 36, 38 is a wire seal or a single strand of solid metallic material. The second and third seal members 36B, 36C, 38B, 38C of each tandem seal 36, 38 are configured to be compressed between the carrier segment 23 and the first seal member 36A, 38A to bias the first seal members 36A, 38A into engagement with the shroud wall 29 of the blade track segment 28, as suggested in FIG. 4. In some embodiments, the first seal members 36A, 38A are biased into engagement with a coating 28A that surrounds the portion of the shroud wall 29 that comes into contact with the seal members 36A, 38A.

In the illustrative embodiment, the second and third seal members 36B, 36C, 38B, 38C are a braid of metallic material, sometimes also referred to as a braid seal. The second and third seal members 36B, 36C, 38B, 38C are a single braid of metallic material in the illustrative embodiment. In some embodiments, the second and third seal members 36B, 36C, 38B, 38C comprise a ceramic-containing core surrounded by the braid of metallic material. The braid of metallic material may form an overbraid sheath around the ceramic core.

In some embodiments, the seal system 34 may further include an aft seal assembly 39 (including similar tandem seals as described above) arranged in a recess 26A formed in the second support wall 26, as shown in FIG. 3. The buffer air seal assembly 34 is located near a forward edge of the blade track segment 28. The aft seal assembly 39 is located near an aft edge of the blade track segment 28. The carrier segment 23 may further include a buffer air passageway at the aft seal assembly 39 similar to the buffer air passageway 64 described above in some embodiments.

Like the buffer air seal assembly 34, the tandem seal of the aft seal assembly 39 includes a first seal member 39A and a second seal member 39B, as shown in FIG. 3. The first seal member 39A and the second seal member 39B each extend circumferentially at least partway about the axis 11. The second seal member 39B is arranged radially outward of the first seal member 39A in the recess 26A and configured to be compressed between the carrier segment 23 and the first seal member 39A to bias the first seal member 39A into engagement with the shroud wall 29 of the blade track segment 28 as suggested in FIG. 3.

Another embodiment of turbine shroud segment 122 is shown in FIGS. 7 and 8. The turbine shroud segment 122 is similar to the turbine shroud segment 22 shown in FIGS. 3-6 and described herein. Accordingly, similar reference numbers in the 100 series indicate features that are common between the turbine shroud segment 122 and the turbine shroud segment 22. The description of the turbine shroud segment 22 is incorporated by reference to apply to the turbine shroud segment 122, except in instances when they conflict with the specific description and the drawings of turbine shroud segment 122.

Similar to the turbine shroud segment 22 described above, the turbine shroud segment 122 includes a first support wall 125 of a carrier segment (not shown in its entirety, but formed substantially similarly to the carrier segment 23 described above) having a recess 132 formed therein. A first cantilevered wall 142 is formed in the recess 132 and includes a main portion 144 and a barrier portion 148 located centrally along the main portion 144. The tandem seals 136, 138 includes first seal members 136A, 138A and second and third seal members 136B, 136C, 138B, 138C that abut the barrier portion 148.

Although the barrier portion 148 provides sufficient means for blocking circumferential movement of the second and third seal members 136B, 136C, 138B, 138C, additional means are provided in this embodiment to secure the second and third seal members 136B, 136C, 138B, 138C. Specifically, the first seal member 136A, 138A can be held in relation to the second seal member 136B, 138B and to the third seal member 136C, 138C via a plurality of retaining members 170, as shown in FIGS. 7 and 8. In some embodiments, two retaining members 170 may be utilized to hold each of the second and third seal members 136B, 136C, 138B, 138C in relation to the respective first seal member 136A, 138A.

As shown in detail in FIG. 8, each retaining member 170 includes a plurality of teeth 170T defining grooves 170G therebetween. Illustratively, the first seal member 136A can be arranged in a radially inward groove 170G formed between a first set of teeth 170T of the plurality of teeth 170T of the retaining member 170 arranged in the first groove 156 and the second seal member 136B can be arranged in a radially outward groove 170G formed between a second set of teeth 170T of the plurality of teeth 170T. Similarly, the first seal member 138A can be arranged in a radially inward groove 170G formed between a first set of teeth 170T of the plurality of teeth 170T of the retaining member 170 arranged in the second groove 158 and the second seal member 138B can be arranged in a radially outward groove 170G formed between a second set of teeth 170T of the plurality of teeth 170T. The retaining members 170 further secure the second and third seal members 136B, 136C, 138B, 138C relative to the first seal members 136A, 138A, further mitigating circumferential movement relative thereto.

Another embodiment of turbine shroud segment 222 is shown in FIGS. 9 and 10. The turbine shroud segment 222 is similar to the turbine shroud segments 22, 122 shown in FIGS. 3-8 and described herein. Accordingly, similar reference numbers in the 200 series indicate features that are common between the turbine shroud segment 222 and the turbine shroud segments 22, 122. The description of the turbine shroud segments 22, 122 are incorporated by reference to apply to the turbine shroud segment 222, except in instances when they conflict with the specific description and the drawings of turbine shroud segment 222.

Similar to the turbine shroud segments 22, 122 described above, the turbine shroud segment 222 includes a first support wall 225 of a carrier segment (not shown in its entirety, but formed substantially similarly to the carrier segment 23 described above) having a recess 232 formed therein. A first cantilevered wall 242 is formed in the recess 232 and includes a main portion 144.

Unlike the turbine shroud segments 22, 122 described above which include a single barrier portion 48, 148, the turbine shroud segment 222 of the present embodiment includes multiple barrier portions 248A, 248B, 248C. In the illustrative embodiment, the first cantilevered wall 242 includes three barrier portions 248A, 248B, 248C that are evenly spaced along the main portion 244 of the first cantilevered wall 242, as shown in FIG. 9. In other embodiments, the barrier portions 248A, 248B, 248C are not evenly spaced along the main portion 244 of the first cantilevered wall 242, and may be positioned along the main portion 244 based on design requirements of the turbine shroud segment 222. In some embodiments, each barrier portion 248A, 248B, 248C can include a unique buffer air passageway 264A, 264B, 264C extending therethrough.

Also unlike the tandem seals 36, 38, 136, 138 described above, the tandem seals 236, 238 only include a first seal member 236A, 238A and a second seal member 236B, 238B, as shown in FIGS. 9 and 10. Accordingly, there are not two seal members arranged on opposing circumferential sides of the barrier portions 248A, 248B, 248C, but instead single seal members 236B, 238B that bend around the barrier portions 248A, 248B, 248C, as will be described in greater detail below.

The first seal member 236A, 238A and the second seal member 236B, 238B each extend circumferentially at least partway about the axis 11 and are generally equal in length. The second seal members 236B, 238B are arranged radially outward of the first seal member 236A, 238A in the recess 232 and configured to be compressed between the carrier segment 23 and the first seal member 236A, 238A to bias the first seal member 236A, 238A into engagement with the shroud wall 29 (which includes coating 228A) of the blade track segment 28 as suggested in FIG. 10.

As shown in FIG. 9, each barrier portion 248A, 248B, 248C includes two axial extensions 249A, 250A, 249B, 250B, 249C, 250C formed similar to the axial extensions 49, 50, 149, 150 described above. Unlike the first support walls 25, 125 described above, the first support wall 225 of this embodiment can include sub-recesses 225A, 225B, 225C, 225D, 225E, 225F formed in the inner walls 232A, 232B of the recess 232 directly opposite the outer walls 251A, 252A, 251B, 252B, 251C, 252C, as shown in FIGS. 9 and 10.

The second seal members 236B, 238B are thus arranged within the grooves 256, 258 to bend around the outer walls 251A, 252A, 251B, 252B, 251C, 252C of the barrier portions 248A, 248B, 248C along the length of the seal members 236B, 238B, as shown in FIG. 9. Accordingly, portions of the seal members 236B, 238B bend axially outwardly away from the barrier portions 248A, 248B, 248C and thus can extend into and rest within the sub-recesses 225A, 225B, 225C, 225D, 225E, 225F formed in the inner walls 232A, 232B of the recess 232. FIG. 10 shows that portions of the second seal members 236B, 238B can extend into the sub-recesses 225C, 225D, and can also compress against the outer walls 251B, 252B of the barrier portion 248B when bending around the outer walls 251B, 252B. The second seal members 236B, 238B can engage the other barrier portions 248A, 248C and sub-recesses 225A, 225B, 225E, 225F in a similar fashion.

The bends of the second seal members 236B, 238B around the barrier portions 248A, 248B, 248C prevent circumferential movement of the second seal members 236B, 238B. Moreover, this embodiment enables the use of a single second seal member 236B, 238B in each tandem seal 236, 238 as opposed to two seal members as shown in the turbine shroud segments 22, 122 described above.

Another embodiment of turbine shroud segment 322 is shown in FIGS. 11-13. The turbine shroud segment 322 is similar to the turbine shroud segments 22, 122, 222 shown in FIGS. 3-10 and described herein. Accordingly, similar reference numbers in the 300 series indicate features that are common between the turbine shroud segment 322 and the turbine shroud segments 22, 122, 222. The description of the turbine shroud segments 22, 122, 222 are incorporated by reference to apply to the turbine shroud segment 322, except in instances when they conflict with the specific description and the drawings of turbine shroud segment 322.

Similar to the turbine shroud segments 22, 122, 222 described above, the turbine shroud segment 322 includes a first support wall 325 of a carrier segment 323 having a recess 332 formed therein. A first cantilevered wall 342 is formed in the recess 332 and includes a main portion 344. The barrier portion 348 of the first cantilevered wall 342 is formed similarly to the barrier portions 48, 148 described above.

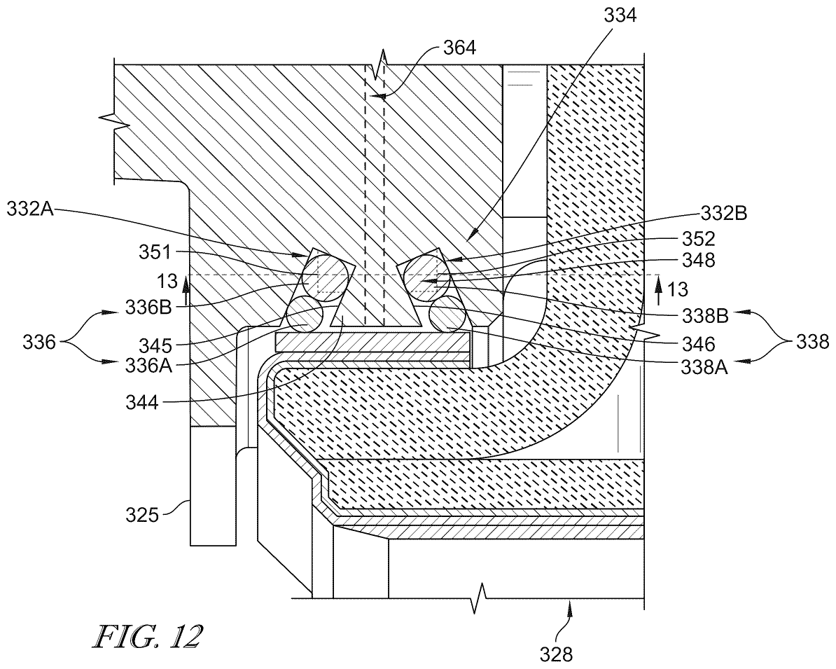

Unlike the main portions 44, 144, the main portion 344 of the first cantilevered wall 342 of this embodiment includes angled outer walls 345, 346. In particular, as shown in FIG. 12, the first and second outer walls 345, 346 are formed to be angled relative to the radial direction (i.e. vertical direction as viewed in FIG. 12). Illustratively, the inner walls 332A, 332B are also angled relative to the radial direction (i.e. vertical direction as viewed in FIG. 12). In some embodiments, the inner walls 332A, 332B and the first and second outer walls 345, 346 are formed to be parallel with each other. In this way, the second and third seal members 336B, 336C, 338B, 338C can securely fit within the grooves 356, 358 without allowing for much or any axial or radial play within the grooves 356, 358. Similar to the first cantilevered walls 42, 142 described above, the second and third seal members 336B, 336C, 338B, 338C are arranged on opposing circumferential sides of the axial extensions 349, 350 of the barrier portion 348 of this embodiment so as to mitigate circumferential movement of the seal members 336B, 336C, 338B, 338C.

A method according to a further aspect of the present disclosure includes a first operational step of arranging a carrier segment 23 made of metallic materials circumferentially at least partway around an axis 11, the carrier segment 23 including an outer wall 24 and a first support wall 25 that extends radially inward from the outer wall 24. The method includes a second operational step of forming the first support wall 25 to include a recess 32 that opens radially inwardly and extends circumferentially at least partway around the axis 11, and a first cantilevered wall 42 extending radially inwardly from a top wall 32C of the recess 32 and spaced apart from opposing inner walls 32A, 32B of the recess 32 so as to form a first groove 56 between a first inner wall 32A of the recess 32 and a first outer wall 45 of the first cantilevered wall 42 that faces the first inner wall 32A, the first cantilevered wall 42 and the first groove 56 extending circumferentially at least partway around the axis 11.

The method includes a third operational step of forming at least one buffer air passageway 64 in the carrier segment 23 that extends radially through the first support wall 25 and the first cantilevered wall 42 and is configured to discharge high-pressure buffer air 66. The method includes a fourth operational step of coupling an attachment feature 29A, 29B of a blade track segment 28 made of ceramic matrix composite materials to the carrier segment 23, the blade track segment 28 including a shroud wall 29 that extends circumferentially partway around the axis 11.

The method includes a fifth operational step of arranging a buffer air seal assembly 34 radially between the carrier segment 23 and the shroud wall 29 of the blade track segment 28, the buffer air seal assembly 34 including a first tandem seal 36 arranged in the first groove 56, the first tandem seal including first, second, and third seal members 36A, 36B, 36C that each extend circumferentially at least partway about the axis 11. The second and third seal members 36B, 36C are aligned with each other, circumferentially spaced apart, and arranged radially outward of the first seal member 36A. The first cantilevered wall 42 further includes a main portion 44 having a first axial width and a barrier portion 48 having a second axial width greater than the first axial width such that a first axial extension 49 of the barrier portion 48 extends at least partially into the first groove 56. The method includes a sixth operational step of arranging the second and third seal members 36B, 36C on opposing circumferential sides 51A, 51B of the barrier portion 48 such that the barrier portion 48 blocks circumferential movement of the second and third seal members 36B, 36C.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine shroud assembly for use with a gas turbine engine, the turbine shroud assembly comprising
a carrier segment made of metallic materials and arranged circumferentially at least partway around an axis, the carrier segment including an outer wall, a first support wall that extends radially inward from the outer wall and is formed to include a recess that opens radially inwardly and extends circumferentially at least partway around the axis, and a first cantilevered wall extending radially inwardly from a top wall of the recess and spaced apart from opposing inner walls of the recess so as to form a first groove between a first inner wall of the recess and a first outer wall of the first cantilevered wall that faces the first inner wall, the first cantilevered wall and the first groove extending circumferentially at least partway around the axis, the carrier segment further including at least one buffer air passageway that extends radially through the first support wall and the first cantilevered wall and is configured to discharge high-pressure buffer air,
a blade track segment made of ceramic matrix composite materials and including a shroud wall that extends circumferentially partway around the axis and an attachment feature coupled to the carrier segment, and
a buffer air seal assembly located radially between the carrier segment and the shroud wall of the blade track segment and including a first tandem seal arranged in the first groove, wherein the first tandem seal includes first, second, and third seal members that each extend circumferentially at least partway about the axis, wherein the second and third seal members are aligned with each other, circumferentially spaced apart, and arranged radially outward of the first seal member, wherein the first cantilevered wall further includes a main portion having a first axial width and a barrier portion having a second axial width greater than the first axial width such that a first axial extension of the barrier portion extends at least partially into the first groove, and wherein the second and third seal members are arranged on opposing circumferential sides of the barrier portion such that the barrier portion blocks circumferential movement of the second and third seal members.

2. The turbine shroud assembly of claim 1, wherein the first support wall of the carrier segment is further formed to include a second groove between a second inner wall of the recess opposite the first inner wall and a second outer wall of the first cantilevered wall that faces the second inner wall and is opposite the first outer wall.

3. The turbine shroud assembly of claim 2, wherein the buffer air seal assembly further includes a second tandem seal arranged in the second groove, wherein the second tandem seal includes fourth, fifth, and sixth seal members that each extend circumferentially at least partway about the axis, wherein the fifth and sixth seal members are aligned with each other, circumferentially spaced apart, and arranged radially outward of the fourth seal member, wherein the barrier portion includes a second axial extension that extends at least partially into the second groove, and wherein the fifth and sixth members are arranged on opposing circumferential sides of the barrier portion such that the barrier portion blocks circumferential movement of the fifth and sixth seal members.

4. The turbine shroud assembly of claim 3, wherein the barrier portion of the first cantilevered wall is located centrally along a longitudinal extent of the main portion.

5. The turbine shroud assembly of claim 4, wherein the main portion of the first cantilevered wall further includes a bottom surface that faces radially inwardly and the first and second axial extensions of the barrier portion each include a bottom surface that faces radially inwardly, and wherein the bottom surfaces of the first and second axial extensions are radially outwardly spaced apart from the bottom surface of the main portion.

6. The turbine shroud assembly of claim 5, wherein the at least one buffer air passageway includes a first buffer air passageway that extends through the barrier portion.

7. The turbine shroud assembly of claim 6, wherein the at least one buffer air passageway includes a second buffer air passageway that extends through the barrier portion and is circumferentially spaced apart from the first buffer air passageway.

8. The turbine shroud assembly of claim 1, wherein the first support wall is a forwardmost support wall of the carrier segment.

9. The turbine shroud assembly of claim 1, wherein the first seal member is a wire seal and the second and third seal members are a braid seal that are compressible, and wherein the second and third seal members are configured to be compressed between the carrier segment and the first seal member to bias the first seal member into engagement with the shroud wall of the blade track segment.

10. The turbine shroud assembly of claim 9, wherein the second and third seal members comprise a braid of metallic material, and wherein the second and third seal members comprise a ceramic-containing core surrounded by the braid of metallic material.

11. The turbine shroud assembly of claim 10, wherein the first seal member comprises a single strand of solid metallic material.

12. The turbine shroud assembly of claim 1, wherein the first seal member is held in relation to the second seal member via a first retaining member and held in relation to the third seal member via a second retaining member.

13. The turbine shroud assembly of claim 12, wherein the first retaining member includes a first plurality of teeth, wherein the first seal member is arranged in a groove formed between a first set of teeth of the first plurality of teeth and the second seal member is arranged in a groove formed between a second set of teeth of the first plurality of teeth, wherein the second retaining member includes a second plurality of teeth, wherein the first seal member is arranged in a groove formed between a third set of teeth of the second plurality of teeth and the third seal member is arranged in a groove formed between a fourth set of teeth of the second plurality of teeth.

14. A turbine shroud assembly for use with a gas turbine engine, the turbine shroud assembly comprising
a carrier segment arranged circumferentially at least partway around an axis, the carrier segment including a first support wall including a recess that opens radially inwardly, and a first cantilevered wall arranged within the recess and spaced apart from opposing inner walls of the recess so as to form a first groove between one of the inner walls and the first cantilevered wall, the carrier segment further including a buffer air passageway that extends radially through the first support wall and the first cantilevered wall,
a blade track segment coupled to the carrier segment, and
a buffer air seal assembly including a first tandem seal arranged in the first groove, wherein the first tandem seal includes first and second seal members, wherein the second seal member is arranged radially outward of the first seal member, wherein the first cantilevered wall further includes a barrier portion, and wherein the second seal member is arranged on a circumferential side of the barrier portion such that the barrier portion blocks circumferential movement of the second seal member.

15. The turbine shroud assembly of claim 14, wherein the buffer air seal assembly is located radially between the carrier segment and a shroud wall of the blade track segment, wherein the first tandem seal further includes a third seal member arranged in the first grooves, and wherein the second and third seal members are aligned with each other, circumferentially spaced apart, and arranged radially outward of the first seal member.

16. The turbine shroud assembly of claim 15, wherein the first cantilevered wall further includes a main portion having a first axial width, wherein the barrier portion has a second axial width greater than the first axial width such that a first axial extension of the barrier portion extends at least partially into the first groove, and wherein the second and third seal members are arranged on opposing circumferential sides of the barrier portion such that the barrier portion blocks circumferential movement of the second and third seal members.

17. The turbine shroud assembly of claim 16, wherein the first support wall of the carrier segment is further formed to include a second groove between the other of the inner walls of the recess and the first cantilevered wall.

18. The turbine shroud assembly of claim 17, wherein the buffer air seal assembly further includes a second tandem seal arranged in the second groove, wherein the second tandem seal includes fourth, fifth, and sixth seal members that each extend circumferentially at least partway about the axis, wherein the fifth and sixth seal members are aligned with each other, circumferentially spaced apart, and arranged radially outward of the fourth seal member, wherein the barrier portion includes a second axial extension that extends at least partially into the second groove, and wherein the fifth and sixth members are arranged on opposing circumferential sides of the barrier portion such that the barrier portion blocks circumferential movement of the fifth and sixth seal members.

19. The turbine shroud assembly of claim 18, wherein the buffer air passageway extends through the barrier portion.

20. A method comprises comprising
arranging a carrier segment made of metallic materials circumferentially at least partway around an axis, the carrier segment including an outer wall and a first support wall that extends radially inward from the outer wall,
forming the first support wall to include a recess that opens radially inwardly and extends circumferentially at least partway around the axis, and a first cantilevered wall extending radially inwardly from a top wall of the recess and spaced apart from opposing inner walls of the recess so as to form a first groove between a first inner wall of the recess and a first outer wall of the first cantilevered wall that faces the first inner wall, the first cantilevered wall and the first groove extending circumferentially at least partway around the axis,
forming at least one buffer air passageway in the carrier segment that extends radially through the first support wall and the first cantilevered wall and is configured to discharge high-pressure buffer air,
coupling an attachment feature of a blade track segment made of ceramic matrix composite materials to the carrier segment, the blade track segment including a shroud wall that extends circumferentially partway around the axis,
arranging a buffer air seal assembly radially between the carrier segment and the shroud wall of the blade track segment, the buffer air seal assembly including a first tandem seal arranged in the first groove, wherein the first tandem seal includes first, second, and third seal members that each extend circumferentially at least partway about the axis, wherein the second and third seal members are aligned with each other, circumferentially spaced apart, and arranged radially outward of the first seal member, wherein the first cantilevered wall further includes a main portion having a first axial width and a barrier portion having a second axial width greater than the first axial width such that a first axial extension of the barrier portion extends at least partially into the first groove, and
arranging the second and third seal members on opposing circumferential sides of the barrier portion such that the barrier portion blocks circumferential movement of the second and third seal members.
